(19) United States
(12) Patent Application Publication
(10) Pub. No.: US 2010/0268899 A1
(43) Pub. Date: Oct. 21, 2010

(54) MEMORY CONTROLLER, NONVOLATILE STORAGE DEVICE, DATA PROCESSING DEVICE, NONVOLATILE STORAGE DEVICE SYSTEM, AND METHOD

(76) Inventors: Hiroki Etoh, Osaka (JP); Shinji Inoue, Osaka (JP); Takuji Maeda, Osaka (JP); Makoto Ochi, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/810,519

(22) PCT Filed: Jul. 1, 2009
(86) PCT No.: PCT/JP2009/003049

§ 371 Date: Jun. 25, 2010

(30) Foreign Application Priority Data
Jul. 1, 2008 (JP) 2008/172042

(51) Int. Cl. G06F 12/00

(52) U.S. Cl. 711/154; 711/E12.001

(57) ABSTRACT

A memory controller (220) that controls the writing of data into or the reading of data from a non-volatile memory (230) includes a host interface unit (210) and a host information management unit (223). The host interface unit (210) receives an application ID identifying an application used when recording user data into the non-volatile memory (230) and a device ID identifying an external device (100) that uses the stated application. The host information management unit (223) records a host information table indicating a correspondence relationship between the application ID and the device ID into the non-volatile memory. The memory controller (220) can thus easily determine by what data processing device the data stored in a non-volatile storage device (200) attachable to/removable from the external device (100) has been updated.

### TECHNICAL FIELD

The present invention relates to memory controllers, non-volatile storage devices, data processing devices, non-volatile storage systems, and methods.

### BACKGROUND ART

There has recently been a spread in semiconductor memories such as SD memory cards, Memory Sticks, and Compact Flash® devices, serving as non-volatile storage devices into or from which digital data can be written or read. The data processing devices that process data using such semiconductor memories are spread throughout a wide variety of fields, including electronic products such as personal computers, audio devices, video devices, mobile telephones, digital cameras, and so on.

Non-volatile storage devices, which are semiconductor memories or the like that are attachable/detachable and feature superior transportability, are particularly useful as bridging media for handling the exchange of data among data processing devices. For this reason, a single non-volatile storage device is often attached to multiple data processing devices. There is therefore the possibility that data that has been stored by a certain data processing device in a non-volatile storage device will be updated by another data processing device. In the past, file systems had been employed as schemes for sharing data among multiple data processing devices, and it was common for data exchanges to be carried out using such file systems.

However, although file systems can be used in a general manner, there are also cases where such file systems do not offer sufficient data management functions, when making use of data through special applications. Accordingly, there are recording schemes called application standards, in which the stream structure, folder structure, and so on of recorded files are specified so that any data processing device can access recorded data in an effective manner. As examples of such application standards, the SD-Video standard is specified for video data and the SD-Audio standard is specified for audio data as rules by which an SD memory card records digital data, and these standards ensure compatibility among data processing devices. File information, the relationship between files, and so on for multiple files recorded in a file system may be extremely important in such application standard-based recording schemes.

However, there are cases where a non-volatile storage device is connected to a typical data processing device such as a PC or the like and files are manipulated in environment that is not compliant with the application standards. For this reason, with such application standard-based recording schemes, in order for a certain data processing device to determine whether or not there is the possibility that the data within a non-volatile storage device has been updated by another data processing device, it has been necessary to actually read out the data recorded in the non-volatile storage device and confirm the content thereof, which has been problematic in that the processing time involved therewith increases in step with the size of the data that is read out.

A technique that provides an update notification unit that is updated immediately before data is written into a non-volatile storage device has been disclosed as a method for determining whether or not data has been updated by a non-volatile storage device (for example, see Patent Citation 1). According to this method, data processing devices can refer to values within the update notification unit, and furthermore, the values in the update notification unit cannot be updated by data processing devices. However, with this method, the values within the update notification unit are updated even when just a single write is made into the non-volatile storage device, and thus this method has been insufficient in reducing the number of times the consistency among files and the like is checked when recording data according to multiple application standards.

Meanwhile, a technique in which the attachment/removal of a non-volatile storage device is confirmed by a lock detection mechanism provided in the slot portion of a data processing device and consistency is maintained by performing control output has been disclosed (for example, see Patent Citation 2 and Patent Citation 3). However, with such a technique, a detection unit such as a detection switch or the like for detecting openings/closings is added to the slot portion, which makes a physical mechanism necessary, and thus increases the cost of the data processing device.

Patent Citation 1: International Publication WO 2005/041050 pamphlet

Patent Citation 2: JP2003-132386A

Patent Citation 3: JP2001-307026A

### DISCLOSURE OF INVENTION

### Technical Problem

Thus, when a non-volatile storage device is attached to multiple data processing devices, it cannot be judged which device performs recording and deletion processes in what manner, and thus a certain amount of time is required for checking the consistency between files (between content data files, or between index files that hold information of content data files or the like); this is problematic in that it consistently takes time before the non-volatile storage device can enter a usable state.

Accordingly, it is an object of the present invention to provide a memory controller, a non-volatile storage device, a data processing device, a non-volatile storage system, and a method capable of easily determining whether data has been appropriately updated in a non-volatile storage device, eliminating unnecessary processes for determining consistencies, and increasing the speed of processing.

### Technical Solution

A first aspect of the present invention is a memory controller configured to control the writing of data into or the reading of data from a non-volatile memory, the memory controller including a host interface unit and a host information management unit. The host interface unit receives an application ID identifying an application used when recording user data into the non-volatile memory and a device ID identifying an external device that uses the application. The host information management unit records a host information table indicating a correspondence relationship between the application ID and the device ID into the non-volatile memory.

Here, recording the application ID and the device ID makes it possible to easily determine whether data within the non-volatile memory has been appropriately updated, eliminate unnecessary processes for determining inconsistencies, and thereby increase the speed of processing.

A second aspect of the present invention is the first aspect, in which the host information management unit updates the host information table before the user data is written into the non-volatile memory.

A third aspect of the present invention is the first or second aspect, in which the host information management unit resets the host information table when the host interface unit has not received the application ID and the device ID before the user data is written into the non-volatile memory.

“Resetting the host information table” as mentioned here refers to, for example, changing the device IDs written in the host information table to an invalid value (that is, that there is no corresponding device).

A fourth aspect of the present invention is a non-volatile storage device including the memory controller according to one of the first through third aspects and a non-volatile memory in which the host information table is recorded.

The non-volatile storage device is capable of being used, for example, as a device such as a memory card in which the memory controller and the non-volatile memory are contained within a dedicated housing or the like, as a module (functional component) device such as an electronic component (an electronic circuit or an integrated circuit) that has the memory controller and the non-volatile memory, or the like.

A fifth aspect of the present invention is the fourth aspect, in which the host information table contains a unique device ID for each application ID.

A sixth aspect of the invention is the fourth or fifth aspect, in which the non-volatile memory has a user-accessible storage region into which the user data is recorded and a host information storage region in which the host information table is recorded. Furthermore, access to the host information storage region is limited more than access to the user-accessible storage region.

A seventh aspect of the present invention is a data processing device that connects to a non-volatile storage device including a non-volatile memory and a memory controller configured to control the writing of data into or the reading of data from the non-volatile memory, and writes user data into or reads user data from the non-volatile storage device. The data processing device includes a data processing unit that outputs, to the non-volatile storage device, a device ID identifying the data processing device and an application ID identifying an application used when recording the user data into the non-volatile storage device.

Here, outputting the application ID and the device ID to the non-volatile storage device makes it possible to easily determine whether data within the non-volatile memory has been appropriately updated, eliminate unnecessary processes for determining inconsistencies, and thereby increase the speed of processing.

An eighth aspect of the present invention is the seventh aspect, in which the data processing unit outputs the device ID and the application ID to the non-volatile storage device before the user data is written into the non-volatile storage device.

A ninth aspect of the present invention is the seventh or the eighth aspect, in which the data processing unit: reads out, from the non-volatile storage device, a host information table indicating a relationship between the application ID identifying an application used when recording the user data and the device ID identifying the data processing device that uses the application; determines whether a device ID that corresponds to the application ID outputted by the data processing unit is present/absent in the host information table; and when the corresponding device ID is not present, determines the consistency of the user data recorded in the non-volatile storage device.

Here, for example, it is possible to easily determine the update status of the data in an unprepared attached non-volatile storage device when that non-volatile storage device is inserted or removed. This makes it possible to quickly determine whether or not a process for determining the consistency is necessary.

A tenth aspect of the present invention is a non-volatile storage system including the non-volatile storage device according to one of the fourth through sixth aspects and the data processing device according to one of the seventh through ninth aspects.

An eleventh aspect of the present invention is a method of controlling the writing of user data into or the reading of user data from a non-volatile memory, using a non-volatile storage device including the non-volatile memory and a memory controller configured to control the non-volatile memory, and a data processing device that connects to the non-volatile storage device, the method including the following. A device ID identifying the data processing device and an application ID identifying an application used when recording the user data into the non-volatile storage device are outputted from the data processing device to the non-volatile storage device. A host information table indicating a correspondence relationship between the application ID and the device ID is then recorded into the non-volatile memory. Finally, the host information table is updated before the user data is written into the non-volatile memory.

Here, outputting the application ID and the device ID to the non-volatile storage device and then updating the host information table in the non-volatile memory that contains the application ID and the device ID before writing the user data makes it possible to easily determine whether data has been appropriately updated in the non-volatile memory and eliminate unnecessary processes for determining inconsistencies, thus increasing the speed of processing.

### ADVANTAGEOUS EFFECTS

According to the present invention, it is possible to easily determine whether data has been appropriately updated in the non-volatile memory and eliminate unnecessary processes for determining inconsistencies, and thus the present invention has an advantage of increasing the speed of processing.

### BRIEF DESCRIPTION OF DRAWINGS

FIG. 1 is a block diagram illustrating a non-volatile storage system according to an embodiment of the present invention.

FIG. 2 is a block diagram illustrating an exemplary configuration of a non-volatile storage device according to an embodiment of the present invention.

FIG. 3 is a diagram illustrating examples of host information, a host information table, and a host information update list.

FIG. 4 is a flowchart illustrating an example of operations performed when a non-volatile storage device receives a host information update list.

FIG. 5 is a flowchart illustrating an example of operations performed when a non-volatile storage device updates a user-accessible storage region.

FIG. 6 is a block diagram illustrating an exemplary configuration of a data processing device according to the present embodiment.

FIG. 7 is a diagram illustrating an example of the structure of user data recorded in a user-accessible storage region.

FIG. 8 is a flowchart illustrating an example of operations performed by a data processing device when a non-volatile storage device is attached to that data processing device.

FIG. 9A is a flowchart illustrating an example of operations performed by a data processing device when power has been restored after the power was interrupted during a data write.

FIG. 9B is a flowchart illustrating another example of operations performed by a data processing device when power has been restored after the power was interrupted during a data write.

### BEST MODE FOR CARRYING OUT THE INVENTION

### 1. Embodiment

### <1.1: Non-Volatile Storage System 1>

Hereinafter, an embodiment of the present invention will be described in detail based on the drawings.

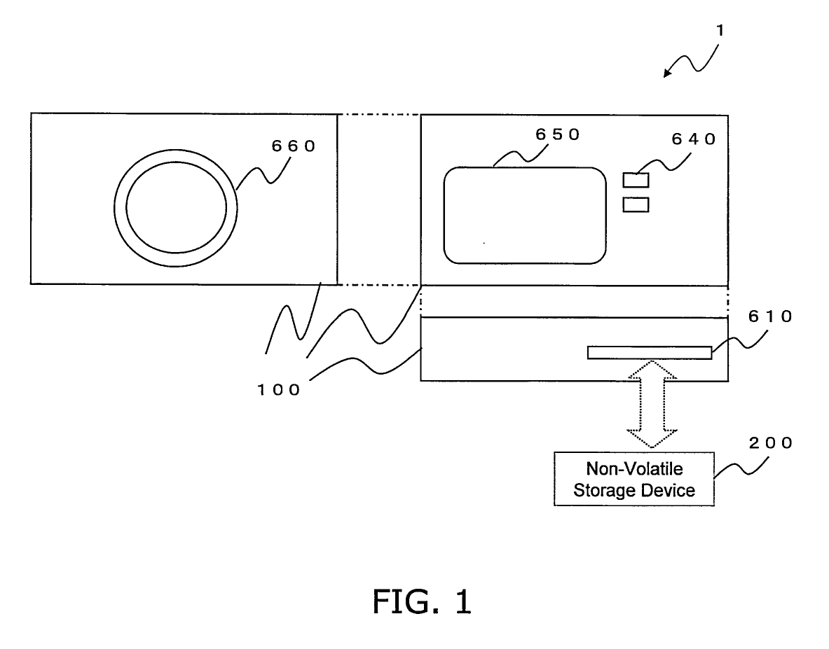

First, a non-volatile storage system 1 according to the present embodiment will be described. FIG. 1 is a diagram illustrating an example of the non-volatile storage system 1. The non-volatile storage system 1 includes a data processing device 100 and a non-volatile storage device 200.

The non-volatile storage device 200 is connected to the data processing device 100 and records various types of data. The non-volatile storage device 200 is, for example, a removable medium such as a memory card or the like.

The data processing device 100 generates various types of data, processes data, and so on, records data into the non-volatile storage device 200 connected thereto, and reads out data from the non-volatile storage device 200. The data processing device 100 is, for example, a digital camera, a video camera, a portable audio player, or the like. In the example shown in FIG. 1, the data processing device 100 is a digital video camera, the non-volatile storage device 200 is a memory card, and these two elements correspond to the primary constituent elements of the non-volatile storage system 1. Note that FIG. 1 merely illustrates one example, and the present invention is not intended to be limited thereto.

Here, the data processing device 100 records captured data (content data), obtained by capturing a video, along with index information, which is accompanying the captured data, into the non-volatile storage device 200.

FIG. 1 illustrates an example in which the data processing device 100 is a digital video camera. In this example, the data processing device 100 includes an imaging unit 660, a display unit 650, a user input unit 640, and a slot 610.

The imaging unit 660 concentrates light using a lens, and converts that light into an electric image signal using an image sensor such as a CCD sensor, a CMOS sensor, or the like. The display unit 650 displays video content data saved in the non-volatile storage device 200 to a user. The user input unit 640 is a unit that the user employs to make operational inputs. Using the user input unit 640, the user can select desired content held within the non-volatile storage device 200 and recognize the details of that content based on details displayed in the display unit 650. The slot 610 is an interface through which the non-volatile storage device 200 is attached to the data processing device 100 and through which data exchange is carried out.

Next, the configurations, operations, and so on of the non-volatile storage device 200 and the data processing device 100 will be described in detail.

### <1.2: Non-Volatile Storage Device 200>

### (1.2.1: Configuration of Non-Volatile Storage Device 200)

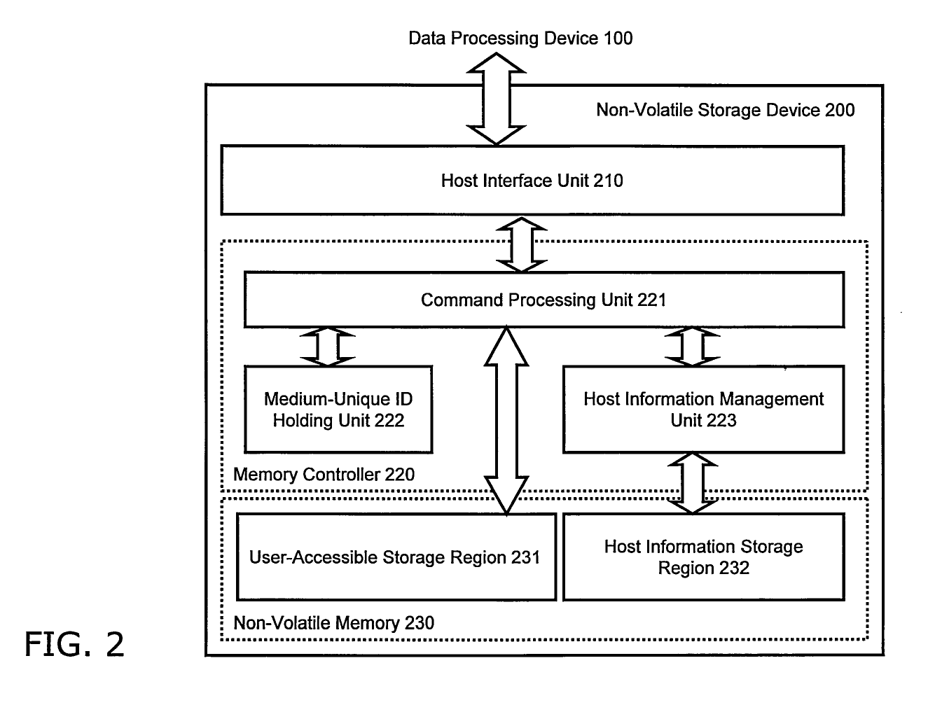

FIG. 2 illustrates an exemplary configuration of the non-volatile storage device 200, which is a memory card (semiconductor memory).

The non-volatile storage device 200 includes a host interface unit 210, a memory controller 220, and a non-volatile memory 230.

The host interface unit 210 exchanges information such as commands, data, and so on with the data processing device 100, which is an external device to which the non-volatile storage device 200 can be attached.

The non-volatile memory 230 holds digital data. The non-volatile memory 230 includes a user-accessible storage region 231 and a host information storage region 232. The user-accessible storage region 231 is a region into or from which any digital data from the data processing device 100 can be written or read. The host information storage region 232, meanwhile, is a region into which only a host information management unit 223 of the memory controller 220 can carry out recording, which will be discussed later. Furthermore, as will be described later, a host information table is recorded in the host information storage region 232, and thus it is desirable for this region to be separate from other regions into which user data and the like recorded by the data processing device 100 is recorded. For this reason, it is preferable for the host information storage region 232 to be a region within the non-volatile memory 230 that has a set access limitation, such as, for example, a region that requires authentication procedures or the like to be carried out before access can be made thereto.

Although a NAND-type flash memory or the like is a common example of a memory used as the non-volatile memory 230, the present embodiment is not limited thereto. Other non-volatile semiconductor memories, such as EEPROMs, FeRAMs, MRAMs, and so on can be employed as well. Furthermore, the present embodiment is not limited to semiconductor memories, and a recording medium such as an HDD may be employed as well.

The memory controller 220 handles internal control of the non-volatile storage device 200. The memory controller 220 is connected to the non-volatile memory 230 and the host interface unit 210. The memory controller 220 includes a command processing unit 221, a medium-unique ID holding unit 222, and a host information management unit 223.

The command processing unit 221 exchanges commands, data, and the like with the data processing device 100 via the host interface unit 210.

The medium-unique ID holding unit 222 holds unique IDs that differ for each non-volatile storage device 200. The data processing device 100 can identify the medium (non-volatile storage device 200) connected thereto by identifying this medium-unique ID.

The host information management unit 223 functions as an interface with the host information storage region 232 of the non-volatile memory 230. As mentioned above, the host information storage region 232 cannot be accessed by the user from the data processing device 100, and instead, the host information management unit 223 writes data into or reads data from the host information storage region 232.

Note that although not shown in the diagrams, in addition to the functions described above, the memory controller 220 also controls the non-volatile storage device 200 as a whole (performing, for example, reset processing, power source control, clock control, memory management, address management, and so on).

### <<Information Management Performed by Host Information Management Unit 223>>

Next, information management performed by the host information management unit 223 will be described.

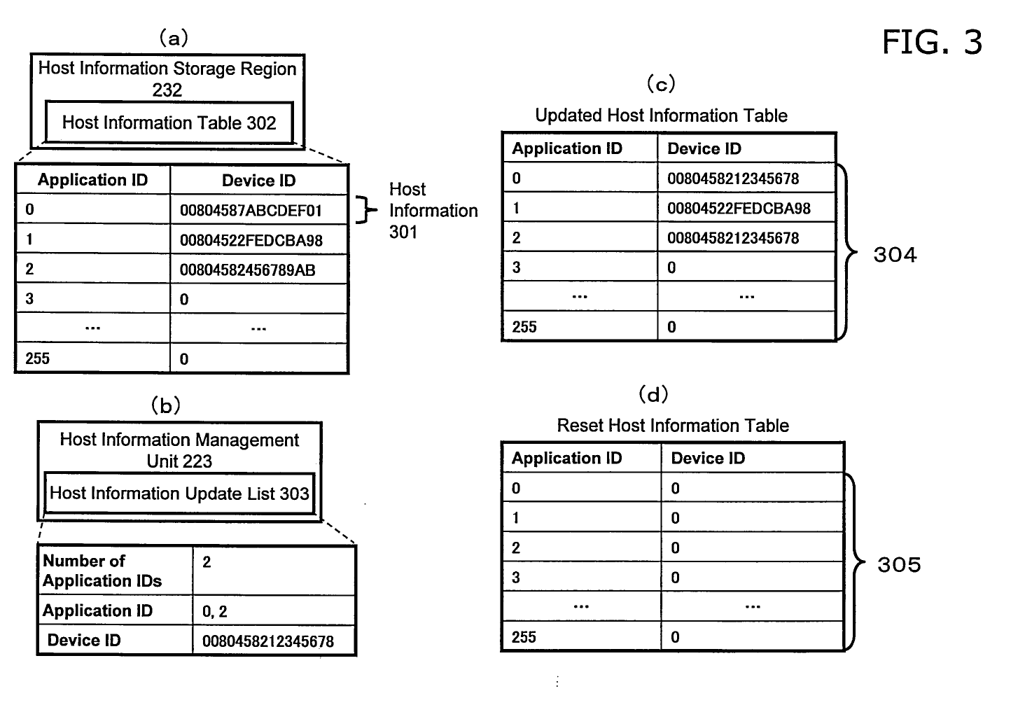

FIG. 3 illustrates the details of information within the non-volatile storage device 200 that is related to the details of processing performed by the host information management unit 223.

FIG. 3(a) illustrates the content of a host information table 302 that contains host information 301 and that is held within the host information storage region 232. FIG. 3(b), meanwhile, illustrates a host information update list 303 within the host information management unit 223. Finally, FIG. 3(c) illustrates a host information table 304 that has been updated based on the host information update list, and FIG. 3(d) illustrates a host information table 305 that has been reset.

The host information table 302 illustrated in FIG. 3(a) is configured of the host information 301. The host information 301 includes a device ID that uniquely identifies the data processing device 100 and an application ID that is identification information indicating the protocol or rule (application) employed when the data processing device 100 writes or updates data in the non-volatile storage device 200. In the example shown in FIG. 3(a), a data processing device 100 having a device ID of, for example, 00804587ABCDEF01, is capable of overwriting or updating data based on a protocol or rule (application) identified by an application ID of 0.

The host information table 302 is a table that indicates device IDs for each of multiple applications based on the aforementioned host information 301. A uniquely-identifiable device ID is indicated for each application. The host information table 302 is recorded in the host information storage region 232 by the host information management unit 223.

The host information update list 303 indicates information of the applications that each data processing device 100 to which the non-volatile storage device 200 is connected can handle. To be more specific, the host information update list 303 is configured of the number of applications (the number of application IDs) that each data processing device 100 can handle, device IDs for identifying the data processing devices 100, and the application IDs that are to be updated by the data processing device 100. In the case where an update is to be carried out based on multiple protocols or rules, multiple application IDs are present within the host information update list 303. The host information update list 303 is recorded in the host information management unit 223.

As described earlier, the host information management unit 223 controls the access made to the host information storage region 232 of the non-volatile memory 230. The host information management unit 223 accepts only some commands sent from the external data processing device 100, and executes access to the host information storage region 232 and the like in accordance with the details of those commands.

Meanwhile, the relationship between the host information management unit 223 and the user-accessible storage region 231 is such that the host information management unit 223 also carries out processes for updating the host information storage region 232 based on the host information update list 303 received from the command processing unit 221 before writing new user data or partially updating existing data in the user-accessible storage region 231.

Note that the host information management unit 223 includes a memory for temporarily storing the host information update list 303.

The host information table 302 is stored in the host information storage region 232, which is a region for storing information related to the data processing device 100. The host information table 302 is capable of being read by the data processing device 100 via the host information management unit 223, the command processing unit 221, and the host interface unit 210.

The host information update list 303 is sent by the data processing device 100, and is temporarily stored in a memory in the host information management unit 223, as indicated in FIG. 3(b). Thereafter, the host information management unit 223 updates the host information table 302 in the host information storage region 232 based on the temporarily-stored host information update list 303 before the data processing device 100 records digital data (user data) into the user-accessible storage region 231.

The sections including the device ID and the application ID in the host information update list 303 held in the host information management unit 223 are cleared when power to the apparatus is turned on, when a reset command or the like issued when the non-volatile storage device 200 has been attached to the data processing device 100 is received, and so on. “Clearing the device ID” refers to actually setting the device ID to 0, which represents an invalid device ID (that is, that there is no corresponding device). “Clearing the application ID”, meanwhile, refers to setting the application ID number field that holds the number of application IDs to 0. Doing so creates a state in which there is no device ID that corresponds to an application ID.

Note that when the non-volatile storage device 200 is manufactured, 0, indicating an invalid device ID (that there is no corresponding device), is written into the application ID values in the host information table 302 of the host information storage region 232. Because access to the host information table 302 is controlled by the host information management unit 223, the data in the host information table 302 cannot be overwritten using a normal command or the like from the data processing device 100. Furthermore, because the host information storage region 232 is recorded in a non-volatile memory, no changes are made to the data when the non-volatile storage device 200 is powered off.

### (1.2.2: Operations of Non-volatile Storage Device 200)

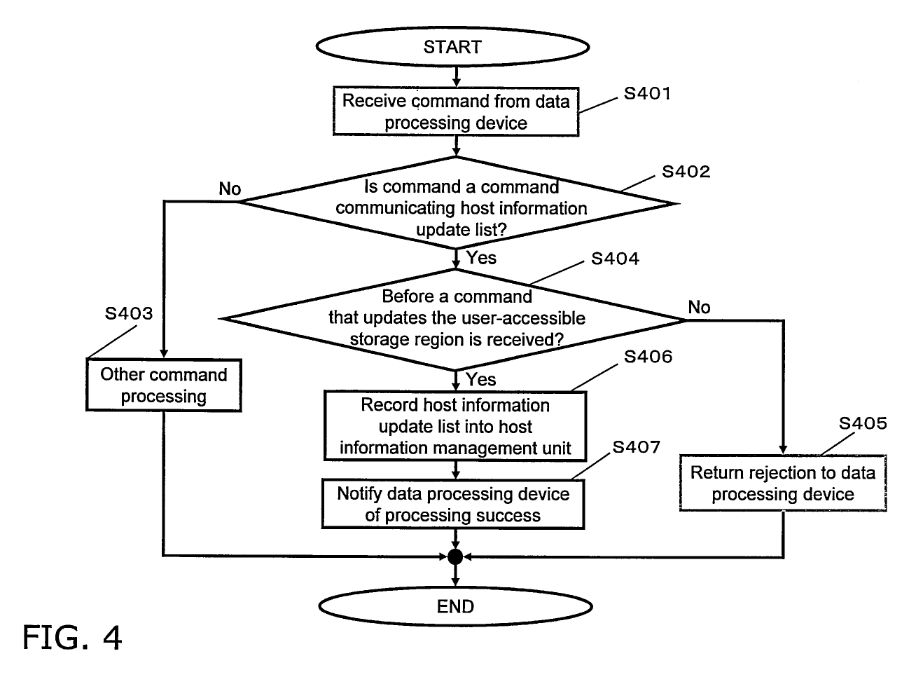

FIG. 4 is a flowchart illustrating an example of operations performed when the non-volatile storage device 200 receives a command, from the data processing device 100, that communicates the host information update list 303.

### (Step S401)

The host interface unit 210 receives a command from the data processing device 100, and communicates the command to the command processing unit 221.

### (Step S402)

The command processing unit 221 determines the type of the command communicated in step S401, and determines whether or not that command is a command that communicates a host information update list. If the command is a command that communicates a host information update list, the process advances to step S404. However, the process advances to step S403 if the command is another type of command.

Note that “another type of command” refers to, for example, a read command for reading data from the user-accessible storage region 231, a write command for writing data into the user-accessible storage region 231, and so on.

### (Step S403)

If the command is not a command that communicates a host information update list, the memory controller 220 performs processing in accordance with that command, and then ends the process.

### (Step S404)

Upon receiving a command that communicates a host information update list, the memory controller 220 determines whether or not a command that updates the user-accessible storage region 231 has been issued after a reset process. A “command that updates the user-accessible storage region 231” refers to a write command for writing data into the user-accessible storage region 231 of the non-volatile memory 230, an erase command for erasing data from the user-accessible storage region 231, or the like. Meanwhile, the “reset process” is a process by which the non-volatile storage device 200 initializes hardware and software settings, and includes clearing memories, setting initial values, and so on.

In the case where a command that updates the user-accessible storage region 231 has not yet been received, the process advances to step S406. However, in the case where such an update command has already been received, the process advances to step S405.

### (Step S405)

In the case where a command that updates the user-accessible storage region 231 has already been received, the memory controller 220 returns a response to the external data processing device 100 rejecting the command from the data processing device 100 via the host interface unit 210, and the process ends.

### (Step S406)

In the case where such an update command has not yet been received, the memory controller 220 records the host information update list received from the data processing device 100 into the host information management unit 223, and the process then advances to step S407.

### (Step S407)

The memory controller 220 then notifies the data processing device 100 that the process has been successful via the host interface unit 210.

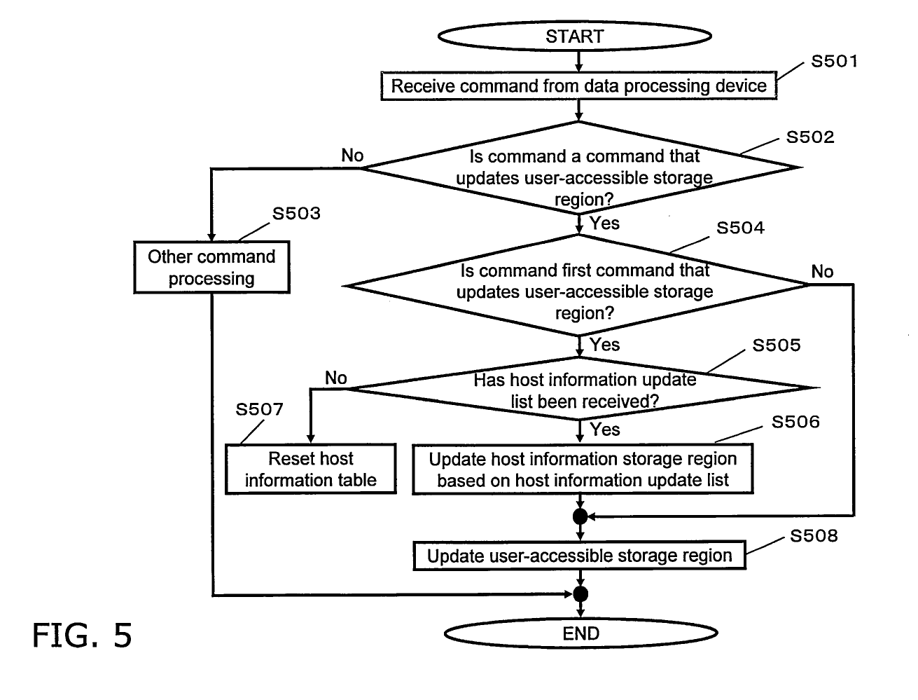

FIG. 5 is a flowchart illustrating an example of operations performed when the non-volatile storage device 200 has received, from the data processing device 100, a command that updates the user-accessible storage region 231.

### (Step S501)

Upon receiving the command from the data processing device 100, the host interface unit 210 communicates that command to the command processing unit 221.

### (Step S502)

The command processing unit 221 then determines whether or not the command is a command that updates the user-accessible storage region 231. In the case where the command is such an update command, the process advances to step S504. However, in the case where the command is another type of command, the process advances to step S503. Note that “another type of command” refers to, for example, a read command for performing a readout or the like.

### (Step S503)

The command processing unit 221 executes the received command (a read or the like), and the process ends.

### (Step S504)

The command processing unit 221 then determines whether or not the command that updates the user-accessible storage region 231 is the first such command that has been received following the reset process. In the case where the command is the first command that updates the user-accessible storage region 231, the process advances to step S505. However, in the case where the command is the second or later command that updates the user-accessible storage region 231, the process advances to step S508.

### (Step S505)

The command processing unit 221 then inquires with the host information management unit 223 as to whether a command communicating a host information update list has been received as a result of the operations indicated in the flowchart shown in FIG. 4. If the result from the host information management unit 223 indicates that a host information update list has already been received, the process advances to step S506. However, in the case where a host information update list has not been received, the process advances to step S507.

### (Step S506)

In the case where the host information update list 303 has been received, the host information management unit 223 updates the host information table 302 stored in the host information storage region 232 based on the host information update list 303 recorded into the host information management unit 223 in step S406 of FIG. 4. The process advances to step S508 after this processing has ended.

“Updating” as mentioned here refers to updating the host information table 302 based on the host information update list 303. To be more specific, the device IDs in the host information table 302 are replaced with the device IDs in the host information update list 303, for the application IDs in the host information table 302 that match application IDs written in the host information update list 303.

For example, in the case where the host information table 302 is as indicated in FIG. 3(a), that host information table 302 is updated based on the host information update list 303 shown in FIG. 3(b). A new host information table 304, as shown in FIG. 3(c), is created as a result. In the updated host information table 304, the device ID “00804512345678” is overwritten for the values for the application IDs 0 and 2 as written in the host information update list 303.

### (Step S507)

In the case where a host information update list has not been received, the host information management unit 223 resets the host information table 302 stored in the host information storage region 232. The process advances to step S508 after this processing has ended.

“Resetting the host information table” as mentioned here refers to changing the device IDs written in the host information table 302 to 0, which indicates an invalid value (that is, that there is no corresponding device). For example, in the case where the original host information table 302 is as shown in FIG. 3(a), performing a reset will result in the host information table 305 as shown in FIG. 3(d) being created. In the post-reset host information table 305, the device IDs corresponding to all the application IDs have been replaced with “0”.

### (Step S508)

The command processing unit 221 executes the received command, and the process ends. For example, in the case where the command is a write command, the user data received from the data processing device 100 is written into the user-accessible storage region 231. Meanwhile, in the case where the command is an erase command, the data in the corresponding address of the user-accessible storage region 231 is erased.

As described thus far, the non-volatile storage device 200 according to the present embodiment updates the values in the host information table 302 recorded in the host information storage region 232 based on the host information update list 303 received in advance, prior to updating the data in the user-accessible storage region 231.

Accordingly, even in the case where another data processing device has been connected, the data processing device 100 has been powered on again, or the like after the non-volatile storage device 200 has been updated by the data processing device 100 that communicates the device IDs and application IDs, the data processing device 100 is capable of specifying by which data processing device the update was performed by reading the host information table 302 in the host information storage region 232, and in the case where the user data has been updated by a different data processing device, the data processing device 100 is capable of identifying what regulations or rules the data processing device that updated the non-volatile storage device 200 adhered to in the update.

### <1.3: Data Processing Device 100>

### (1.3.1: Configuration of Data Processing Device 100)

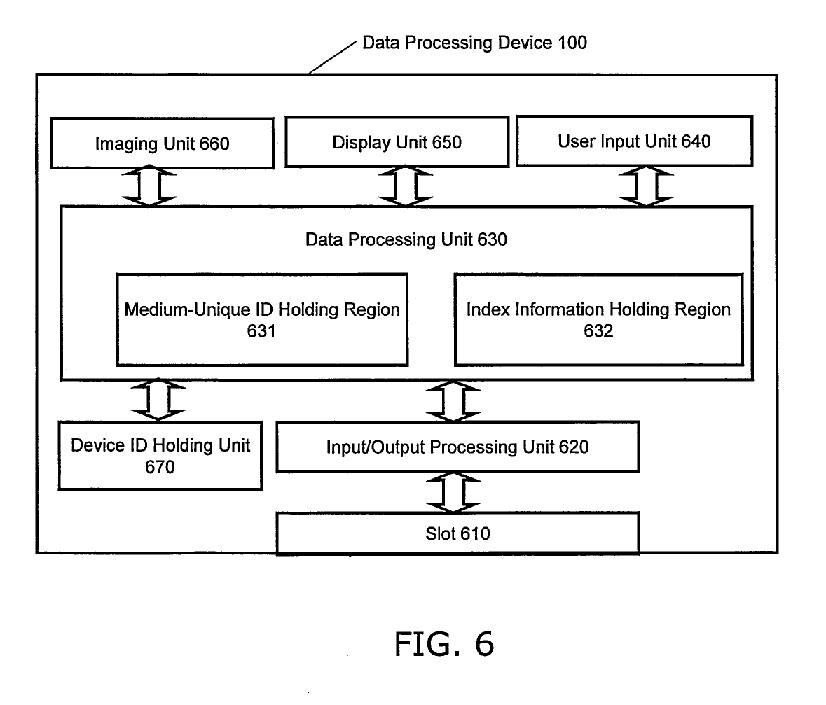

Next, the data processing device 100 according to the present embodiment will be described. FIG. 6 is a block diagram illustrating an exemplary configuration of the data processing device 100.

In addition to the aforementioned slot 610, user input unit 640, display unit 650, and imaging unit 660, the data processing device 100 includes an input/output processing unit 620, a data processing unit 630, and a device ID holding unit 670.

The slot 610 is part of an interface for attaching the external non-volatile storage device 200.

The input/output processing unit 620 is part of an interface for exchanging information such as commands, data, and the like with the non-volatile storage device 200 that has been attached to the slot 610.

The data processing unit 630 is an element that processes data that is held in the non-volatile storage device 200 connected to the slot 610 or data that is to be held therein thereafter. For example, in the case where the data held in the non-volatile storage device 200 that is connected to the slot 610 is audio data, video data, or the like, the processing unit 630 controls operations for reading out the data via the input/output processing unit 620, writing user data that has been recorded/edited into the non-volatile storage device 200 via the input/output processing unit 620, and so on.

Note that the data processing unit 630 may also perform control for other types of data processing (for example, playing back read-out data, recording captured data, and so on), functions for controlling the data processing device 100 as a whole (power control, clock control, and the like), and so on.

The data processing unit 630 includes a memory (not shown), which serves as a temporary storage region used in the processing of data. This memory includes a medium-unique ID holding region 631 and an index information holding region 632.

The medium-unique ID holding region 631 records a medium-unique ID read out from the medium-unique ID holding unit 222 of the non-volatile storage device 200 connected to the slot 610.

The index information holding region 632 is a region that holds information of index files recorded in the user-accessible storage region 231 of the non-volatile storage device 200. The information of the index files will be described in detail later. Meanwhile, the index information holding region 632 includes a memory that temporarily holds various types of data such as index files. This memory is not limited to a volatile memory, and a non-volatile memory may be employed as well.

The user input unit 640 is an element that accepts inputs from the user. The display unit 650 is an element that notifies the user of the results of processing performed by the data processing unit 630, the progress of various processes, and so on. The imaging unit 660 sends, to the data processing unit 630, a digital image signal obtained from an image sensor that converts light into an electric image signal using an element such as a CCD (charge-coupled device), a CMOS (complementary metal-oxide semiconductor), or the like.

The device ID holding unit 670 holds a device ID, which is an identifier that uniquely specifies the data processing device 100. Unique values are allocated to each data processing device as device IDs. The device ID is set when the data processing device is manufactured.

### <<Index File Information>>

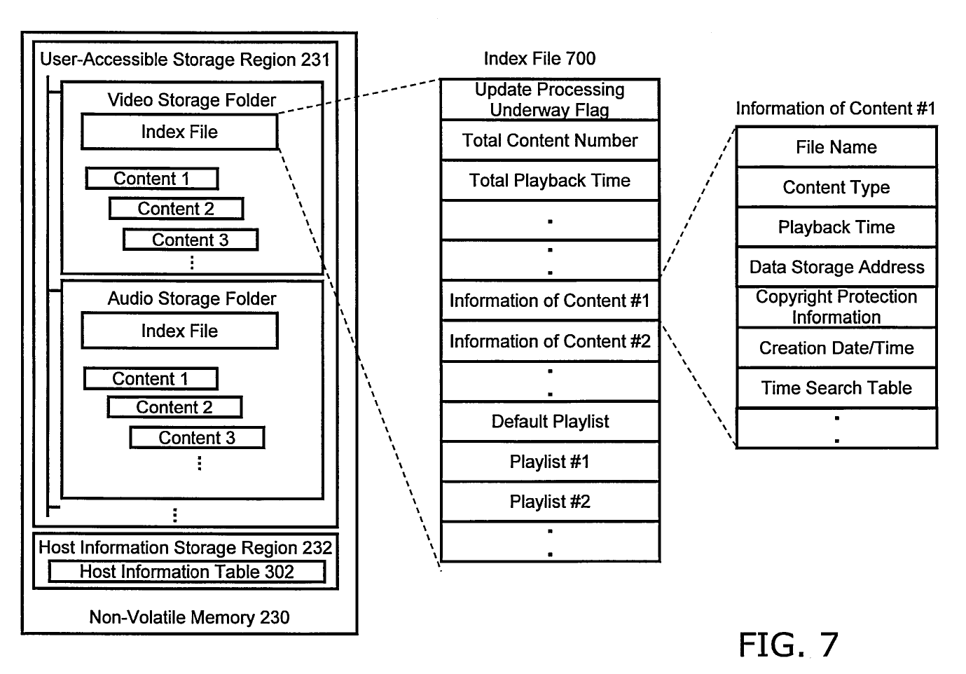

The index file information held in the index information holding region 632 is, as shown in FIG. 7, recorded in the user-accessible storage region 231 of the non-volatile memory 230. FIG. 7 illustrates the structure of the user data in the user-accessible storage region 231.

In the present embodiment, each piece of user data is recorded into an independent folder for each protocol or rule (application). In each folder, a content file and an index file are held in a file format specified by a certain protocol or rule (application).

In the present embodiment, at least one content file and index file are held in each folder. However, other files may be held therein as well. The “content files” referred to here are files through which the data processed by the data processing device 100 are managed in file format, and are files that hold user data such as music, videos, still images, and the like.

Meanwhile, an index file 700 is a file that holds information regarding multiple content files, and specifically includes fields that hold information such as that described hereinafter. These fields include an update underway flag, the total number of pieces of content, the total playback time, content information, playlists, and so on.

The update underway flag is set to 1 before a process for updating the index file, the content files, or the like is commenced, and is set to 0 when that updating process ends; this flag indicates information of accesses to file groups. The total number of pieces of content is a value that indicates the total number of content files that are recorded in the folder. The total playback time is the total time required to play back all of the content files recorded in the folder.

The content information is data indicating detailed information for each of the content files. Specifically, this information includes a content file name; the type of the content, such as music, video, or still images; the playback (processing) time of the content; a physical or logical data storage address in the storage region in which the content file is held; information indicating playback conditions, copying conditions, or copyright protection of the content; the creation date/time of the content; a time search table indicating data addresses that match specific times in video/music; and so on.

A playlist is data denoting an order of playback for the content files within the folder.

Information necessary when displaying a list of the content files is consolidated within the index file 700. This index file 700 makes it possible to search the content files in a comparatively easy manner, which in turn makes it possible to lighten the processing burden on the data processing device 100.

In the present embodiment, recording addresses and the like are managed using the FAT file system, and the information required for the FAT file system is assumed to be stored in a predetermined search information holding region. Note that another file system, such as UDF or the like, may be employed, or the recording addresses and the like may be managed without employing a file system.

### (1.3.2: Operations of Data Processing Device 100)

Operations performed by the data processing device 100 will be described hereinafter using the diagrams, discussing related operations performed by the non-volatile storage device 200 in tandem.

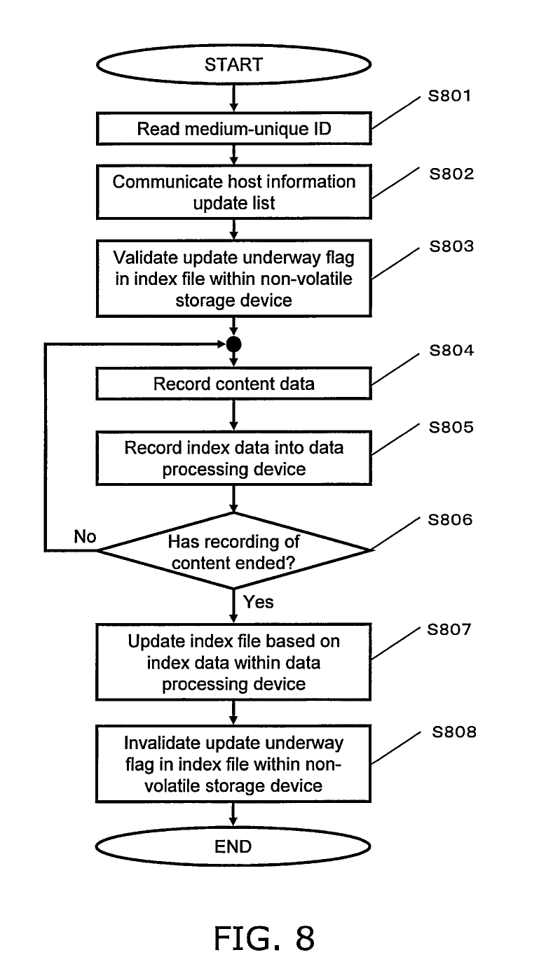

FIG. 8 is a flowchart illustrating an example of operations performed when updating the user-accessible storage region 231 when the non-volatile storage device 200 is attached to the data processing device 100. Although the present embodiment describes a sequence for recording data captured by the imaging unit 660 into the non-volatile storage device 200, the digital data to be recorded need not be data from the imaging unit 660.

### (Step S801)

The data processing unit 630 loads, into the medium-unique ID holding region 631, the medium-unique ID recorded in the medium-unique ID holding unit 222 of the non-volatile storage device 200 attached to the slot 610, via the input/output processing unit 620.

### (Step S802)

When an instruction to commence imaging is inputted through the user input unit 640, the data processing unit 630 generates a host information update list from the device ID recorded in the device ID holding unit 670 and the application IDs that are to be updated. The data processing unit 630 then communicates the generated host information update list to the non-volatile storage device 200 attached to the slot 610, via the input/output processing unit 620. Meanwhile, the non-volatile storage device 200 records the host information update list that has been communicated thereto in the host information management unit 223 of the non-volatile storage device 200 (steps S402, S404, and S406 in FIG. 4).

### (Step S803)

The data processing unit 630 then accesses the non-volatile storage device 200, and changes the update underway flag in the index file 700, which in turn is in a folder of the application standard that is to be changed recorded in the user-accessible storage region 231, from 0 (invalid) to 1 (valid).

At this time, the index file 700 is located in the user-accessible storage region 231, and therefore changing this flag is equivalent to updating the user-accessible storage region 231. For this reason, the non-volatile storage device 200 updates the host information table 302 within the host information storage region 232 based on the host information update list communicated to the non-volatile storage device 200 in step S802, as per the processing sequence illustrated in FIG. 5 (the processes in steps S502, S504, S505, and S506).

### (Step S804)

The data processing unit 630 converts image data from the imaging unit 660 into a format based on a predetermined application standard and, after a certain amount of image data has been accumulated, outputs the data via the input/output processing unit 620. The outputted image data is recorded in content files and the like within the user-accessible storage region 231 of the non-volatile storage device 200. In the case where content files have already been recorded, the data is added to those content files.

### (Step S805)

The data processing unit 630 stores, in the index information holding region 632 within the data processing device 100, index data related to the image data recorded in the non-volatile storage device 200 in step S804.

### (Step S806)

If the user has issued a command to end the imaging via the user input unit 640, the data processing unit 630 advances the process to step S807. However, if a command to end the imaging has not been issued, the process returns to step S804, and the recording of image data is continued.

### (Step S807)

When the imaging ends, the data processing unit 630 updates the index file 700 (FIG. 7) of the application standard to be changed in the user-accessible storage region 231 of the non-volatile storage device 200, based on the index data held in the index information holding region 632 within the data processing device 100.

### (Step S808)

The data processing unit 630 then changes the update underway flag within the index file of the application standard that is to be changed in the user-accessible storage region 231 from 1 (valid) to 0 (invalid), and the process ends.

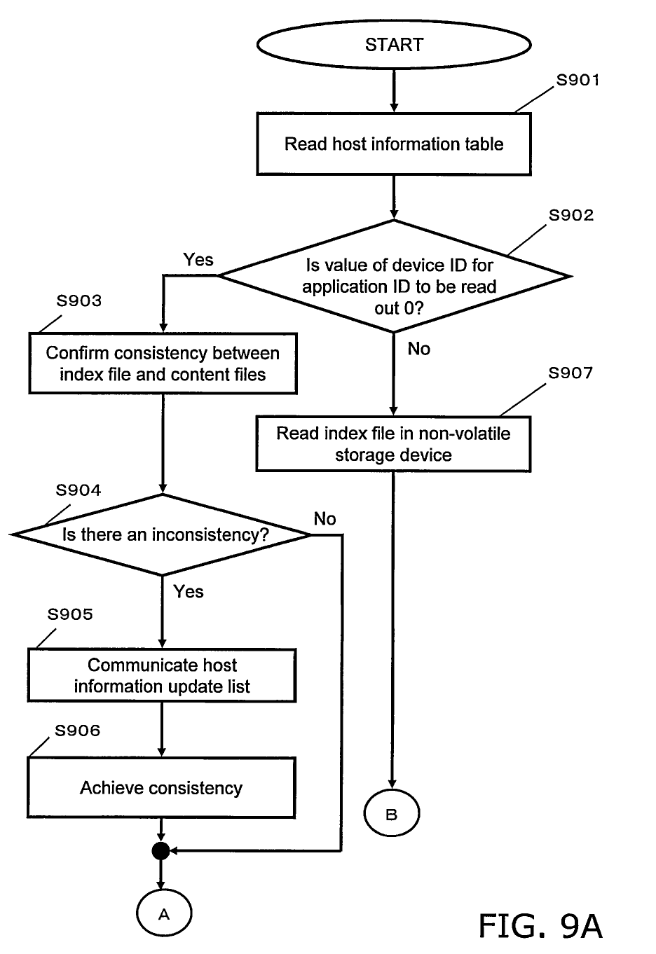

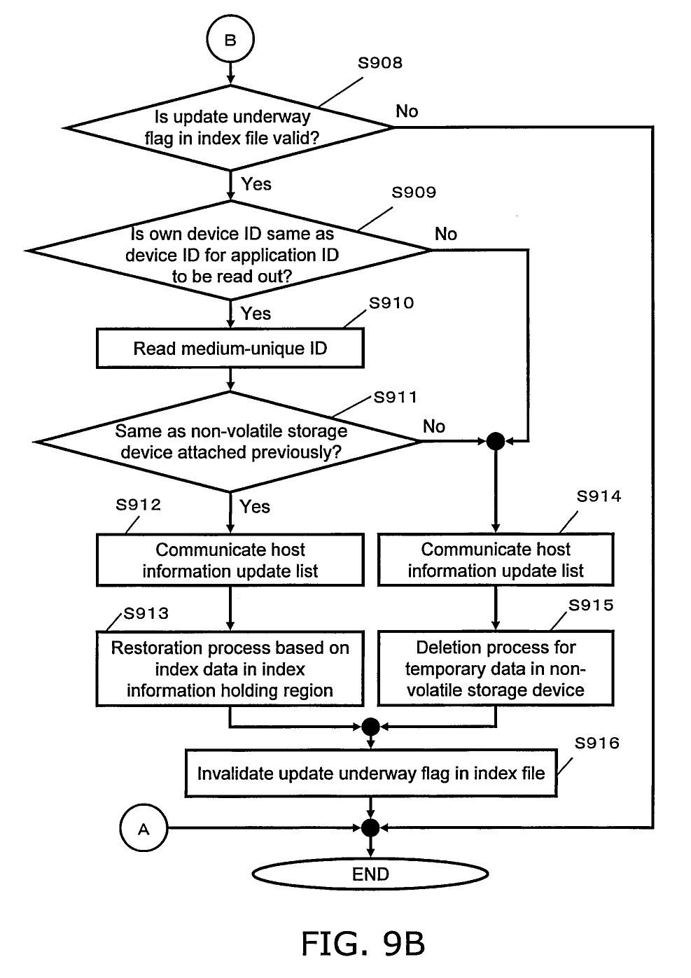

FIGS. 9A and 9B are flowcharts illustrating a recovery process performed after power has been restored in the case where the non-volatile storage device 200 has been attached to the data processing device 100 and the power was cut off while data was being written.

### (Step S901)

The data processing unit 630 accesses the non-volatile storage device 200 attached the slot 610 via the input/output processing unit 620, and reads out values from the host information table 302 stored in the host information storage region 232 via the host information management unit 223 of the non-volatile storage device 200.

### (Step S902)

The data processing unit 630 then confirms the value of a device ID, recorded in the host information table 302 that was read out in step S901, corresponding to the application ID for readout. In the case where the value of the device ID is 0, the process advances to step S903. However, in the case where the value is a value aside from 0, the process advances to step S907.

### (Step S903)

A device ID of 0, indicating an invalid value, indicates that a host information update list has not been communicated by the data processing device 100, or that the host information table has been reset (step S507 in FIG. 5). This means that there is a possibility that the non-volatile storage device 200 has, prior to being attached to the data processing device 100, been updated by a device that is not the data processing device 100 and that is not compliant with the application standard for readout.

Accordingly, the state is one in which there is no guarantee that consistency is being maintained between the index file and the content files. For example, there are situations where a data processing device that is not compliant with the application standard does not have index file functionality. With such a device, the index file is not updated even if content data is written, deleted, or the like, and inconsistencies arise between the index file and the content files as a result. In order to prevent such a problem from occurring, the data processing unit 630 reads the index file and all the content files, and determines the consistency therebetween.

In order to determine whether or not the index file 700 and the content files within the non-volatile memory 230 are consistent, it is necessary to determine whether or not each item of data recorded in the index file 700 (the index file 700, content information, and so on shown in FIG. 7) conforms with the actual details of the content files on an individual basis. For this reason, the data processing device 100 analyzes the data and the like of the individual content files, and compares each item of data within the index file with the actual details of the respective content files.

### (Step S904)

In the case where the result of the data processing unit 630 confirming the compatibility in step S903 indicates that an inconsistency has occurred, the process advances to step S905. However, if there are no inconsistencies, the process ends.

### (Step S905)

In the case where there is an inconsistency, the data processing unit 630 communicates the host information update list to the non-volatile storage device 200 attached to the slot 610, via the input/output processing unit 620. The non-volatile storage device 200 then records the communicated host information update list in the host information management unit 223 (step S406 in FIG. 4).

### (Step S906)

The data processing unit 630 then accesses the non-volatile storage device 200 and modifies the index file 700 and all of the content files so as to achieve consistency therebetween, in accordance with information of the consistencies between the index file 700 and all the content files as confirmed in step S903. Prior to modifying the index file 700 and the content files, the update underway flag in the index file 700 is changed from 0 to 1, and when the modification is complete, the update underway flag is changed from 1 back to 0.

Note that in order to “achieve consistency”, in the case where, for example, a content file has been deleted but information regarding the deleted content file remains in the index file 700, that information is deleted from the index file 700. Alternatively, in the case where a content file for which no information is recorded in the index file 700 is present, the details of the content file are confirmed, and the information of the content file is registered in the index file 700 or the content file is handled as an unknown content file and is deleted.

### (Step S907)

In the case where the device ID value read in step S902 is a value aside from 0, the data processing unit 630 reads the index file 700. This means that an update was made by a data processing device compliant with the application standard before the non-volatile storage device 200 was attached to the data processing device 100, or in other words, that the information written within the index file 700 is correct.

### (Step S908)

In the case where the update underway flag in the index file 700 read in step S907 is 0, it is determined that the consistency between the index file 700 and all the content files of the application standard for readout in the non-volatile storage device 200 has been maintained, and the process ends.

### (Step S909)

The data processing unit 630 then confirms the value of a device ID, recorded in the host information table 302 that was read out in step S901, corresponding to the application ID for readout. In the case where the value of that device ID is the same as a value held in the device ID holding unit 670 of the data processing device 100 (in other words, that the data processing device 100 is a device that previously operated that application), the process advances to step S910. In the case where the value of that device ID is different than the value held in the device ID holding unit 670, the process advances to step S914.

### (Step S910)

The data processing unit 630 reads the medium-unique ID of the non-volatile storage device 200 attached to the slot 610, via the input/output processing unit 620.

### (Step S911)

The data processing unit 630 compares the medium-unique ID read in step S910 with the value held in the medium-unique ID holding region 631, and determines whether or not the value is the same as the non-volatile storage device for which recording processing was carried out immediately previous thereto. If the non-volatile storage device is the same as the device for which recording processing was carried out immediately previous thereto, the process advances to step S912. However, if the device is different, the process advances to step S914.

Note that the ID of the medium (non-volatile storage device) read in step S801 in the flowchart shown in FIG. 8 is held in the medium-unique ID holding region 631.

### (Step S912)

The process reaching this step indicates a state in which the update processing was interrupted partway through due to some reason, such as the non-volatile storage device 200 being removed and reattached while the data processing device 100 was performing update processing, the power source being interrupted, and so on. For this reason, the data processing unit 630 communicates the host information update list to the non-volatile storage device 200 attached to the slot 610, via the input/output processing unit 620.

### (Step S913)

The data processing unit 630 updates the index file 700 of the non-volatile storage device 200 based on index data remaining in the index information holding region 632 (a cache memory), thus maintaining the consistency between the index file 700 and the content files.

### (Step S914)

The process reaching this step indicates a state in which the update processing was interrupted partway through for some reason, such as the non-volatile storage device 200 being removed during the update processing and then being reattached, and in which the index data held in the index information holding region 632 within the data processing unit 630 is not consistent with the content files and thus cannot be used. For this reason, the data processing unit 630 communicates the host information update list to the non-volatile storage device 200 attached to the slot 610, via the input/output processing unit 620.

### (Step S915)

The data processing unit 630 deletes the content files (temporary data) for which no index information is present in the index file 700 of the non-volatile storage device 200, thus maintaining consistency between the index information and the content files. Note that as a different method, in the case where the content files can be restored, the data of remaining content files can be recovered, and so on, the information of those content files may be added to the index file rather than deleting those content files.

### (Step S916)

The data processing unit 630 changes the update underway flag in the index file of the application standard for readout in the user-accessible storage region 231 of the non-volatile storage device 200 from 1 to 0.

After the aforementioned operational sequence for power on/startup has been completed, the data processing device 100 processes the data held in the non-volatile storage device 200 using a user input received through the user input unit 640 as a trigger. If there is no user input unit 640, processing of the data held in the non-volatile storage device 200 may be commenced automatically by software held in the data processing unit 630. Furthermore, during the respective operational sequences, the display unit 650 may display the state of progress, operational results, and so on to the user.

### <1.4: Effects of the Embodiment>

As described thus far, when accessing the non-volatile storage device 200, the data processing device 100 according to the present embodiment uses the values in a host information table recorded in the host information storage region 232 that is outside of the user-accessible storage region 231 of the non-volatile storage device 200. Through this, when the non-volatile storage device 200 is attached, it can be easily determined which data processing device updated the data in the non-volatile storage device 200 and according to what application standard the update was made. Therefore, it is no longer necessary to continuously check for consistency every time the data processing device 100 is powered on, and thus the processing can be accelerated in cases where a process for determining the consistency is unnecessary.

Furthermore, combining this with the update underway flag within the index file of the non-volatile storage device 200 makes it possible to easily determine the update status of an unprepared attached non-volatile storage device 200 when the non-volatile storage device 200 is inserted or removed. Through this, a high-speed data recovery process can be carried out based on the index information remaining within the data processing device 100.

Although the present invention has been described based on the aforementioned embodiment, it should be noted that the invention is of course not limited to the embodiments discussed above. Many variations can be made within a scope that does not depart from the spirit of the present invention. The invention is also inclusive of the following cases.

### [2 Variations]

(1)

Although in the aforementioned embodiment, the operational sequence illustrated in FIG. 4 described the host information update list (FIG. 3(b)) as the content of the notification sent from the data processing device 100 to the non-volatile storage device 200 in the processing of step S406, the device ID and the application ID may be sent separately.

(2)

Although the aforementioned embodiment described indicating which application standard the recording was based upon using an application ID, denoted as a number, in the host information storage region 232 of the non-volatile storage device 200, identification information written based on a different rule, such as a folder name or the like, may be used as well. In other words, no limitation is placed on the format of this information as long as it is capable of identifying an application.

(3)

Although the aforementioned embodiment described the non-volatile storage device 200 as a semiconductor memory, the effects of the invention are applicable as long as the non-volatile storage device 200 is a non-volatile storage device that is capable of being attached/removed and to and from which data can be written and read. For example, a detachable HDD may be used as a non-volatile storage device instead of a semiconductor memory. Furthermore, even in a case where the drive and a storage medium are separate, as with an optical storage device for DVDs, BDs, or the like, the present invention can be applied by providing the memory controller unit in the aforementioned embodiment in the drive and the non-volatile memory in the storage medium.

(4)

Although the aforementioned embodiment described the data processing device 100 as having a single slot 610 in order to facilitate understanding the points of the present invention, multiple slots may be provided as well. In such a case, the non-volatile storage device 200 may be provided with the same number of medium-unique ID storage regions and index data storage regions as there are slots.

(5)

Although the update underway flag is provided in the index file in the aforementioned embodiment, the flag may be provided in an independent file instead. An update start command and an update end command may be used, and a storage region may be provided in the host information storage region 232. Meanwhile, these commands may be stored on an application ID-by-application ID basis.

(6)

In the aforementioned embodiment, when the data processing device 100 is powered on and started up, the data processing unit 630 clears the values in the medium-unique ID holding region 631 and the index information holding region 632, and thus when the data processing device 100 is powered off, the information in the cache is erased. However, the values of the medium-unique ID holding region 631 and the index information holding region 632 may be stored within a non-volatile memory so that the information in the cache is not erased even if the data processing device 100 is powered off. Conversely, a means for forcefully resetting the index information may be provided as well.

(7)

Although the aforementioned embodiment described the device IDs as being allocated when the device is manufactured, the device IDs may be allocated at any time as long as they can be set before the non-volatile storage device 200 is updated. For example, IDs sent via a network from a server that allocates unique device IDs may be used as well.

(8)

Although the aforementioned embodiment described an example in which the data processing device 100 communicates the host information update list to the non-volatile storage device 200 and the host information update list is stored in the host information management unit 223 as-is, the host information update list may be communicated to the non-volatile storage device 200 using an encryption technique. For example, a key that is known only to a corresponding application may be recorded in the host information storage region 232 when the non-volatile storage device 200 is manufactured, and the host information list may then be communicated to the non-volatile storage device 200 by the data processing device 100 after the list is encrypted using the aforementioned key. Doing so makes it possible for only the manufacturer of the data processing device 100 who is in a position of knowing the key to communicate the host information list, which in turn makes it possible to increase the reliability of the host information table 302.

(9)

In the aforementioned embodiment, some or all of the content files and index files may be encrypted.

(10)

Although the aforementioned embodiment described two regions, or the user-accessible storage region 231 and the host information storage region 232, as being provided in a single non-volatile memory 230, the host information storage region 232 does not need to be located within the non-volatile memory 230. Instead, two non-volatile memories 230 may be connected to the memory controller, and the user-accessible storage region may be provided in one of the memories, and the host information storage region may be provided in the other memory. It is possible to realize faster processing by providing two non-volatile memories. Alternatively, a non-volatile storage region may be provided within the memory controller, and the host information storage region may then be provided in the non-volatile storage region within the memory controller. All variations are possible as long as the information in the host information storage region is not erased even if the power to the non-volatile storage device 200 is interrupted, the non-volatile storage device 200 is removed/attached to/from the data processing device 100, and so on.

### INDUSTRIAL APPLICABILITY

The present invention is applicable in still image recording/playback devices, video recording/playback devices, mobile telephones, or the like that use a non-volatile storage device such as a semiconductor memory card or the like.

### EXPLANATION OF REFERENCE

100 data processing device
200 non-volatile storage device
210 host interface unit
220 memory controller
221 command processing unit
222 medium-unique ID holding unit
223 host information management unit
230 non-volatile memory
231 user-accessible storage region
232 host information storage region
301 host information
302 host information table
303 host information update list
610 slot
620 input/output processing unit
630 data processing unit
631 medium-unique ID holding region
632 index information holding region
640 user input unit
650 display unit
660 imaging unit
670 device ID holding unit
700 index file

1. A memory controller configured to control writing of data into or reading of data from a non-volatile memory, the memory controller comprising:
a host interface unit configured to receive an application ID identifying an application used when recording user data into the non-volatile memory and a device ID identifying an external device that uses the application; and
a host information management unit configured to record a host information table indicating a correspondence relationship between the application ID and the device ID into the non-volatile memory.

2. The memory controller according to claim 1,
wherein the host information management unit updates the host information table before the user data is written into the non-volatile memory.

3. The memory controller according to claim 1 or 2,
wherein the host information management unit resets the host information table when the host interface unit has not received the application ID and the device ID before the user data is written into the non-volatile memory.

4. A non-volatile storage device comprising:
a memory controller; and
a non-volatile memory in which a host information table is recorded,
the memory controller being configured to control writing of data into or reading of data from the non-volatile memory, the memory controller including:
a host interface unit configured to receive an application ID identifying an application used when recording user data into the non-volatile memory and a device ID identifying an external device that uses the application; and
a host information management unit configured to record the host information table indicating a correspondence relationship between the application ID and the device ID into the non-volatile memory.

5. The non-volatile storage device according to claim 4,
wherein the host information table contains a unique device ID for each application ID.

6. The non-volatile storage device according to claim 4,
wherein the non-volatile memory includes a user-accessible storage region into which the user data is recorded and a host information storage region in which the host information table is recorded; and
access to the host information storage region is limited more than access to the user-accessible storage region.

7. A data processing device that connects to a non-volatile storage device including a non-volatile memory and a memory controller configured to control writing of data into or reading of data from the non-volatile memory, and writes user data into or reads user data from the non-volatile storage device, the data processing device comprising:
a data processing unit configured to output, to the non-volatile storage device, a device ID identifying the data processing device and an application ID identifying an application used when recording the user data into the non-volatile storage device.

8. The data processing device according to claim 7,
wherein the data processing unit outputs the device ID and the application ID to the non-volatile storage device before the user data is written into the non-volatile storage device.

9. The data processing device according to claim 7,
wherein the data processing unit:
reads out, from the non-volatile storage device, a host information table indicating a relationship between the application ID identifying an application used when recording the user data and the device ID identifying the data processing device that uses the application;
determines whether a device ID that corresponds to the application ID outputted by the data processing unit is present/absent in the host information table; and
when the corresponding device ID is not present, determines consistency of the user data recorded in the non-volatile storage device.

10. A non-volatile storage system comprising:
a non-volatile storage device; and
a data processing device that connects to the non-volatile storage device and writes user data into or reads user data from the non-volatile storage device,
the data processing device including a data processing unit configured to output, to the non-volatile storage device, a device ID identifying the data processing device and an application ID identifying an application used when recording the user data into the non-volatile storage device,
the non-volatile storage device including a memory controller and a non-volatile memory in which a host information table is recorded, the memory controller being configured to control writing of data into or reading of data from the non-volatile memory, the memory controller including a host interface unit configured to receive the application ID and the device ID, and a host information management unit configured to record the host information table indicating a correspondence relationship between the application ID and the device ID into the non-volatile memory.

11. A method of controlling writing of user data into or reading of user data from a non-volatile memory, using a non-volatile storage device including the non-volatile memory and a memory controller configured to control the non-volatile memory, and a data processing device that connects to the non-volatile storage device, the method comprising:
outputting, from the data processing device to the non-volatile storage device, a device ID identifying the data processing device and an application ID identifying an application used when recording the user data into the non-volatile storage device;
recording a host information table indicating a correspondence relationship between the application ID and the device ID into the non-volatile memory; and
updating the host information table before the user data is written into the non-volatile memory.
